(19) United States
(12) Patent Application Publication
(10) Pub. No.: US 2008/0127534 A1
(43) Pub. Date: Jun. 5, 2008

(54) Reflection message card holder and method of displaying an image on a surface

(76) Inventor: Jane K. Brown, Bloomington, MN (US)

Correspondence Address: Richard O. Bartz, Suite 350, 6750 France Avenue South, Edina, MN, 55435, US

(21) Appl. No.: 11/633,015

(22) Filed: Dec. 4, 2006

(51) Int. Cl. G09F 19/12

(52) U.S. Cl. 40/1

(57) ABSTRACT

A holder with a card having a reverse printed message, slogan or image is located on the dashboard of a motor vehicle adjacent the bottom of the vehicle's windshield whereby the mirror image of the reverse printed message is reflected on the windshield and read by the driver and/or passengers.

### FIELD OF THE INVENTION

The invention relates to card holders used to reflect printed messages and designs from cards retained in the holders onto a surface such as a mirror and transparent glass. More particularly, the invention relates to a reflection message card holder and method to display a mirror image of a message contained in the card holder onto the windshield of a motor vehicle.

### BACKGROUND OF THE INVENTION

Cards with scripture, messages or slogans have been incorporated into many portable display devices such as decorative desktop holders, window cling material, framed prints or posters, loose card decks and pocket card holders. One drawback to portable direct read holders and front read cards is the need to have them in a convenient place, within your line of sight or viewing for a long period so the reader can meditate on them. Portable normal reading cards typically use gravity, static electricity, a case or adhesives to hold the cards within view. Viewing surfaces in use are mostly on desks, bookshelves, counters, or other flat surfaces within the office or household. A drawback to what is currently in the marketplace today is that most message cards are either direct quotes from the Bible or statements that are generic. In other words, there is a need for messages that a reader can make their own. Messages that are “I” statements or affirmations that the reader can take ownership of, thus having a greater impact in being internalized and taking hold in a person's being. There is a need for affirmation messages or slogans that can be read in a place where people spend a great majority of their time and in a reflective state and where they do a lot of thinking. Reading messages offers a positive change in one's perspective from anxiety to a feeling of calm and self-assuredness.

Persons today spend a great amount of time in their automobiles commuting, traveling, and running errands. When driving or as a passenger, persons tend to do a lot of thinking, planning, and contemplation. The average person in the U.S. spends 51 minutes a day commuting to work. That's 221 hours a year, or 9.2 days. And since it's an average, that means there are persons who spend several hours commuting every day. Between 1990 and 2000, there was a 95 percent increase in the number of persons who have a commute of 90 minutes or more. Added to long commutes is increased congestion, according to the Texas Transportation Institute's 2005. Urban Mobility Report. Commuters typically spent 47 hours a year in traffic jams, up from 40 hours a decade earlier. This endless commute is becoming the defining characteristic of the 21st-century working person. So much of what we worry about today, our health, relationships, money, our overstressed lives, ail merge together on the road, as we search for the answers to a simple, fulfilling life. Message cards or slogans of encouragement, empowerment, comfort and hope ride along with the driver and passengers, floating the words on the windshield, offering positive thoughts during your drive time. There is a need for persons to remember messages that will uplift their moods, their goals, their focus. Using vision to memorize text in your mind is extremely helpful for recall. A common excuse is that persons “don't have enough time” to study. By having the reflecting messages near your line of vision during drives will expose plenty of opportunity for visualizing and memorizing the messages, thus making the commitment for memorization easy.

### SUMMARY OF THE INVENTION

The invention relates to a visual information display apparatus and method of displaying visual information on a light reflective surface. The display apparatus includes sheet members having reverse or backward printed matter, slogans or designs retained on a holder adapted to be positioned adjacent a light reflective surface, such as a window, mirror or vehicle window. The sheet members are individual paper or plastic cards containing the reverse or backward printed matter. The holder has a substantially flat body and retainers for holding the cards on top of the body with the reverse or backward printed matter exposed. The holder is located on a support adjacent the light reflective surface to position the top card to reflect forward printed matter on the light reflective surface. The included angle between the top card on the holder and light reflective surface is an acute angle of between 10 to 80 degrees whereby a person in front of the card and light reflective surface can view the mirror image of the printed matter reflected on the light reflective surface.

The present invention provides a set of messages, slogans or information on cards encased in a high heat tolerant rigid plastic holder. The card messages are printed with white or light colored letters in reverse on a black or dark colored background. Created for use on a vehicle's dashboard, they are positioned toward the windshield where the white letters of the cards will then reflect off the lower portion of the windshield. The holder is also black or of a dark color so it will not reflect and recede into the transparency of the interior reflection. The holder includes non-slip or adhesive strips on the back of the holder where it meets the dashboard of the vehicle. The non-slip action or adhesive prevents the holder from sliding across the dashboard when the car is turning. When the vehicle is parked or stopped, the driver or a front seat passenger can easily lift the holder from the dashboard with one hand and then remove the top exposed card in the holder for another card in the set. The upper card can simply be slipped out and back in the deck to expose another message, slogan or statement. Cards are printed double sided to offer more messages retained in the slim and low profile holder. The reflection of the message from the top card onto the windshield is activated by daylight or streetlights shining through the windshield from the outside and onto the card, thus reflecting the message back onto the inside windshield. Advantageously, the combined card and holder is adaptable for use in any vehicle, truck, boat, or reflective surface such as windows and mirrors. The visual display apparatus is to be marketable in various retail focuses and customized for private label industries.

The entire set of cards and holder is inexpensive can affordably be used on a widespread basis for a variety of applications. As a result, retailers in various markets, counselors, coaches, and private companies needing sales and marketing tools in a multitude of industries could provide such a system to their customers and staff for promotional, leadership, teambuilding, training and slogan memorization purposes. In addition, the cards and holder is light, easy to use, and provides empowering, uplifting messages to accomplish a variety of functional goals to individuals and corporate groups. The system is fabricated from non-toxic, heat resistant plastic, silicone, and paper component materials so that a hazard is not caused within the vehicle.

### DESCRIPTION OF THE DRAWING

FIG. 1 is a perspective view of the reflection message card holder of the invention;

FIG. 2 is a front plan view thereof;

FIG. 3 is a back plan view thereof;

FIG. 4 is a bottom plan view thereof;

FIG. 5 is a top plan view thereof;

FIG. 6 is a side elevational view of the left side thereof;

FIG. 7 is a side elevational view of the right side thereof;

FIG. 8 is an enlarged foreshortened sectional view taken along the line 8-8 of FIG. 2;

FIG. 9 is a perspective view of the front section of an automobile showing the reflection message card holder with a message card on the dashboard of the automobile;

FIG. 10 is an enlarged top plan view of the reflection message card holder of FIG. 1 accommodating a message card containing a mirror image message; and

FIG. 11 is an enlarged sectional view taken along the line 11-11 of FIG. 9.

### DETAILED DESCRIPTION OF THE INVENTION

In the following detailed description of the cards and holder, reference is made to the accompanying drawing that form a part hereof, and in which are shown, by way of illustration, specific embodiments in which the invention may be practiced. It is to be understood that other embodiments may be utilized and structural changes may be made without departing from the scope of the present invention.

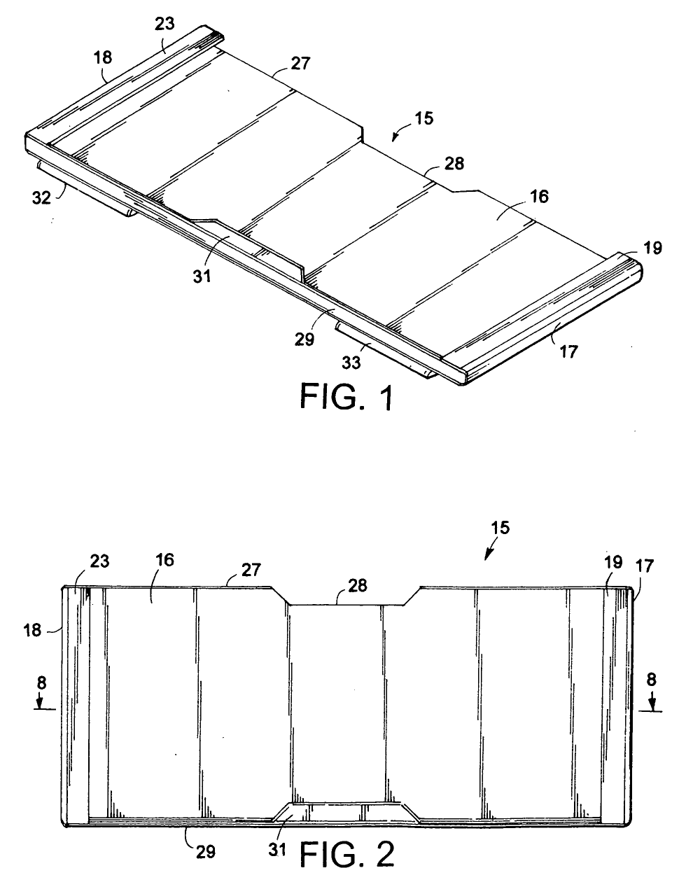

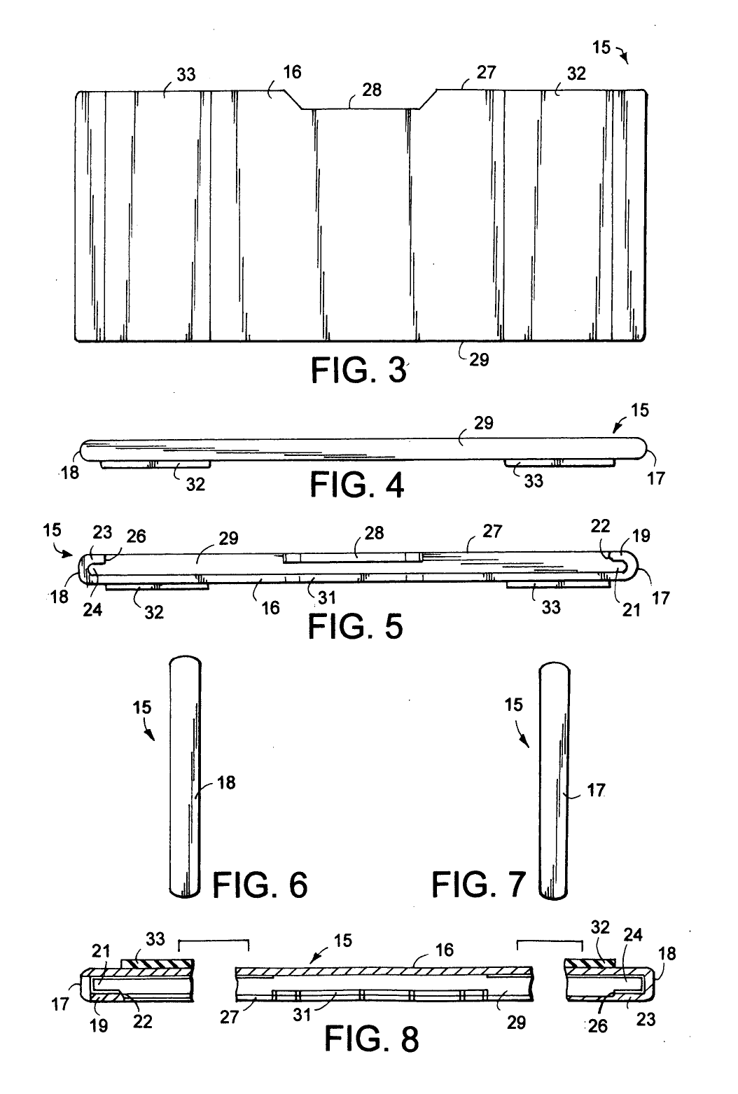

As shown in FIGS. 1 to 8, card holder 15 has a generally rectangular body 16 having a flat top surface and parallel opposite end walls 17 and 18. A first flange 19 joined to end wall 17 extends inwardly over and above a transverse first end portion of body 16 providing a transverse space or slot 21 for accommodating one end of a message card 39. The inner edge 22 of flange 19 has an inwardly directed taper to facilitate insertion of one or more cards into slot 21. A second flange 23 joined to end wall 18 extends inwardly over and above a transverse second end portion of body 16 providing a space or slot 24 for accommodating the other end of message card 39. The inner edge 26 of flange 23 tapers inwardly. The top edge 27 of body 16 has a central recess 28 providing a space to allow a person to grip one or more cards to place cards in holder 15 or remove cards form holder 15. The bottom wall 29 of body 16 is joined to an upwardly extended lip 31 spaced above a middle section of the top surface of body 16. Lip 31 functions to retain the middle portions of one or more cards in flat surface engagement with the top surface of body 16. Lip 31 cooperates with flanges 19 and 23 to retain one or more cards flat on the top surface of body 16 thereby locating the cards in a horizontal plane and allow the cards to be inserted through the open ends of slots 21 and 24 into engagement with bottom wall 29 and to be removed from holder 15. Flanges 19 and 23 and lip 31 also keep the cards from blowing out of and warping in holder 15. End walls 17 and 18 and bottom wall 29 are engaged with end and bottom edges of the cards to maintain the rectangular alignment of the cards on the top surface of body 16.

As shown in FIGS. 1, 3 and 11, a pair of non-slip pads 32 and 33 are attached to the back of body 16. Pads 32 and 33 are rectangular members that extend from top edge 27 to bottom wall 29 adjacent end walls 17 and 18. The material of pads 32 and 33 has a high coefficient of friction and surface adhesion characteristics. Plastic and rubber-like materials can be used to fabricate pads 32 and 33. An adhesive or bonding material secures pads 32 and 33 to the back surface of body 16. Pads 32 and 33 can be replaced with pressure adhesives or Velcro strips to secure holder 15 to a support. As shown in FIG. 11, pads 32 and 33 retain holder 15 on a dashboard 38 of a motor vehicle 34.

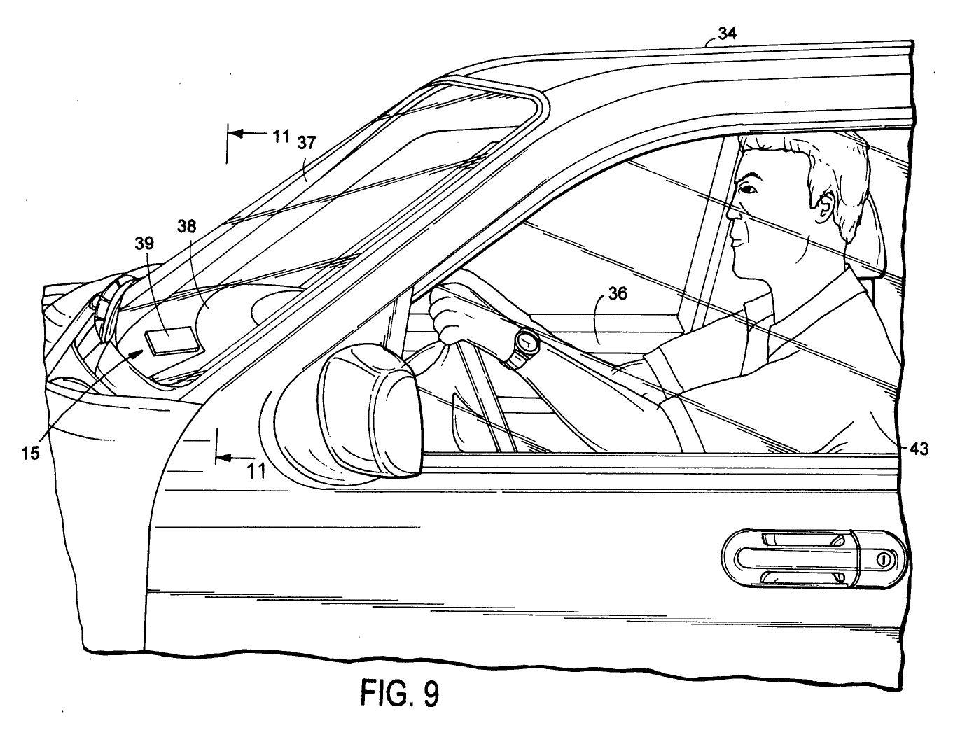

As shown in FIGS. 9 and 11, card holder 15 retaining a card 39 is located on a dashboard 38 of a motor vehicle 34, shown as a passenger automobile, adjacent the bottom of the vehicle's windshield 37. The motor vehicle can be an automobile, truck, tractor motorcycle, boat or motorhome. Windshield 37 is a convex curved sheet of light transparent glass extended upwardly and rearwardly at an angle of about 40 degrees from dashboard 38. The inclination of motor vehicle windshield varies with the different models of motor vehicles. The included angle between the card holder 15 on a dashboard 38 and the windshield 37 is between 10 to 80 degrees so that vehicle operator 43 in the driver's position or compartment 36 can readily observe the message or printed matter 42 reflected on the bottom portion of windshield 37. Holder 15 is placed flat on dashboard 38 with pads 32 and 33 adhering or clinging to the surface of dashboard 38 to prevent holder 15 from shifting along dashboard 38 or moving into the passenger or driver's compartments of motor vehicle 34.

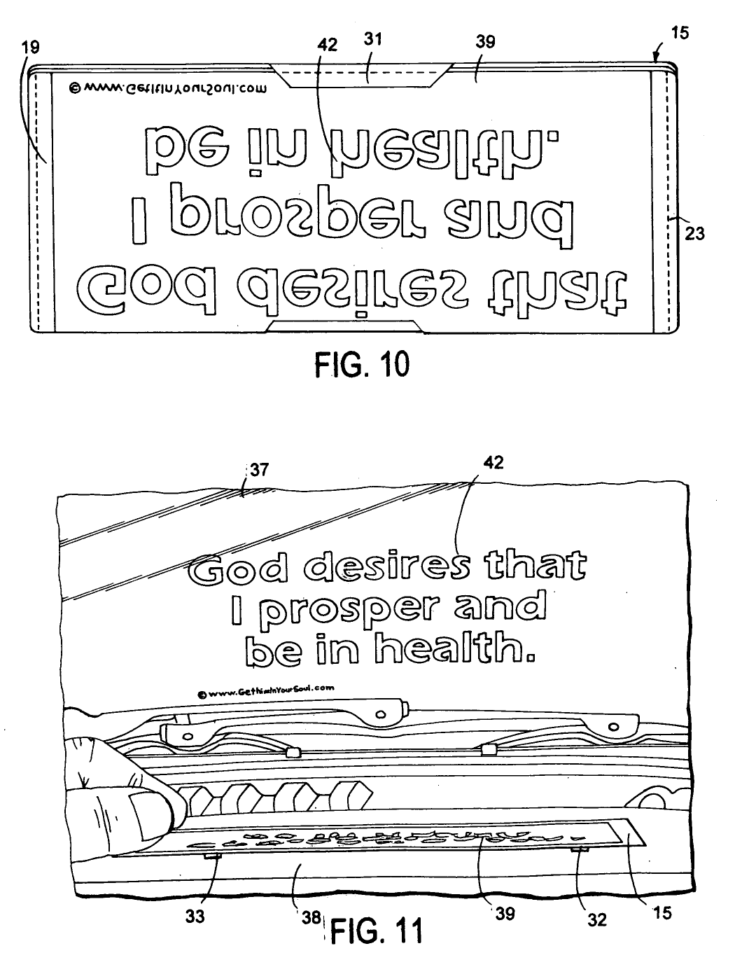

As shown in FIG. 10, card 39 containing a reverse or backward printed message, shown as reverse printed words 42, is positioned in holder 15 opposite end portions of the card located under flanges 19 and 23 and a middle edge portion located under lip 31. Message 42 can be logos, images or slogans in white or light-colored reverse graphics on a black or dark colored background. Opposite sides of the cards can contain reverse printed messages. The cards can be paper stock or plastic sheet material. A plurality of cards with different messages can be retained on holder 15.

Holder 15 is a one-piece molded plastic member made of black polypropylene, designed to withstand the extremes in hot and cold temperatures of the motor vehicle's dashboard. Other types of materials can be used to mold holder 15. An example of holder 15 has a body six (6) inches long and a width of two and one-half (2.5) inches high. Card 39 is a paper sheet stock having the dimensions of approximately six (6) inches long and two and one-half (2.5) inches wide with the message 41 point size of 30 to 44 and limit of 2 to 5 lines of text on a black background suitable for reading from the front seat to the windshield. A holder and cards having these dimensions are suitable for economical printing. An advantageous feature of holder 15 only containing approximately eight cards is that it results in the product having a slim profile, thus being thin and low to the dashboard, creating no obstruction to the drivers view or having a cumbersome thick holder full of cards that becomes heavy and more apt to come loose from its position on the dashboard. Additionally, having only approximately eight cards to be handling, shuffling, and exchanging for a new card to expose on the dashboard is easier on the user.

In use, as shown in FIGS. 9 and 11, holder 15 with card 39 is placed on dashboard 38 at the bottom of windshield 37 in horizontal alignment with the vehicle's operator 43. As shown in FIG. 11, the available light on the exterior of the automobile entering the windshield hits card 39 and reflects message 41 on windshield 37. The placement and positioning of the holder 15 near or at the area where dashboard 38 meets windshield 37 brings the reflection of message 41 to the lower portion of the windshield and permits the driver to shift his attention from the reflected words, message, or image to the view of traffic conditions ahead of the vehicle without a great change in the focus or his eyes. With reflected message 41 below the view of the operator to traffic conditions ahead of the vehicle, it is oriented out of the directed sight line of the operator. The operator's use is similar to reading any other device within the vehicle, such as the time, radio station, speed and mileage requiring the expected and typical horizontal and vertical movements of the eyes and slight movements of the head made by the operator and passengers. This enhances the safety of holder 15 and card 39. Additionally, the objects blocked by the reflection of the words, text, or image from the card would be the hood of the car and windshield wipers. When operator 43 momentarily reads the reflected message 41 on windshield 37, the operator also reads a street or highway sign, dashboard instruments, radio and time displays. It is recommended that the operator or passenger remove, change cards, and replace holder 15 from its position on the dashboard 38 when the vehicle is in the parked position. This reduces the incidence for distraction from developing traffic conditions, road perceptions or an errant release of the foot from the brake while reaching for holder 15 on the dashboard.

Advantageously, considering the stressed lives of people today, the entertainment and comfort value received from the messages floating on their automobile windshields will be well received in the retail marketplace. The combined cards and holder is inexpensive. As a result, these cards and holder can affordably be used on a widespread basis. As a result, more people will benefit from the messages. In addition, these cards and holder are entertaining, fun, and provide positive thoughts and attitudes for the readers. The cards and holder are fabricated from non-toxic materials so that a hazard is not being used with a product or device.

It is to be understood that the above description is intended to be illustrative, not restrictive. Numerous characteristics and advantages of the various messages, slogans, and images retained in the holder as described herein have been set forth in the foregoing description together with details of the structure and function of the holder and cards. The scope of the invention should, therefore, be determined with reference to the appended claims, along with the full scope of equivalents to which such claims are entitled.

1. A holder for supporting one or more cards comprising: a body having a substantially flat top surface adapted to support a card, said body having end walls and a bottom wall extended between the end walls adapted to locate the card on said top surface of the body, and flanges joined to the end walls extended over end portions of the top surface adapted to retain the card on said top surface of the body.

2. The holder of claim 1 including: a lip joined to the bottom wall extended over a portion of the top surface of the body adapted to cooperate with said flanges to retain the card on said top surface of the body.

3. The holder of claim 2 wherein: said lip is joined to a middle portion of said bottom wall.

4. The holder of claim 1 wherein: said body has a top edge, said top edge having a recess adapted to facilitate removal of the card from the holder.

5. The holder of claim 1 wherein: said body has a top edge generally parallel to the bottom wall, said top edge having a middle section and a recess in said middle section adapted to facilitate removal of the card from the holder and placement of the card on the holder.

6. The holder of claim 1 including: a pad secured to the body for retaining the holder on a support.

7. The holder of claim 1 including: a plurality of pads secured to the body opposite the top surface for adhering to a support.

8. The holder of claim 1 wherein: the body has a substantially flat bottom surface, and a pair of rectangular pads secured to the bottom surface for retaining the holder on a support.

9. The holder of claim 1 wherein: said body is a rectangular member having opposite ends and generally flat top and bottom surfaces, said end walls being linear end walls joined to the opposite ends of the body, said flanges being generally flat linear members joined to the end walls and extended over portions of the opposite ends of the top surface of the body, a lip joined to the bottom wall extended over a portion of the top surface of the body, said flanges and lip cooperating to retain one or more cards on the holder.

10. The holder of claim 9 including: a pair of pads secured to the bottom surface for retaining the holder on a support.

11. The combination of a holder and one or more cards comprising: a holder including a body having a substantially flat top surface, a card located on said top surface, said card containing visual information viewable by a person, and retainers joined to the body to hold the card on the body.

12. The combination of claim 11 wherein: said body has end walls and a bottom wall extended between the end walls, said retainers including flanges joined to the end walls and extended over and above end portions of the top surface to retain end portions of the card on the top surface of the body.

13. The combination of claim 12 wherein: said retainers include a lip joined to the bottom wall extended over and above a portion of the top wall, said lip cooperating with said flanges to retain the card on the top surface of the body.

14. The combination of claim 13 wherein: said body is a rectangular flat member having a flat top surface, said card is a flat rectangular sheet member located in parallel alignment on said top surface, said visual information on the card being reverse printed words, message, slogans or images.

15. The combination of claim 14 wherein: the card has a dark background and light reverse printed words.

16. The combination of claim 11 wherein: the body has a bottom surface opposite the top surface and at least one pad secured to the bottom surface for retaining the holder on a support.

17. The combination of claim 11 wherein: said body has a top edge generally parallel to the bottom wall, said top edge having a recess open to a portion of the card to facilitate manual removal of the card from the holder and placement of the card on the holder.

18. The combination of claim 11 including: a motor vehicle having a windshield and a dashboard located adjacent the bottom of the windshield, said holder and card on the holder being located on the dashboard adjacent the bottom of the windshield, said visual information on the card being reverse printed words whereby the forward printed words are reflected on the windshield.

19. The combination of claim 18 wherein: said card has a dark background and light reverse printed words.

20. A method of displaying a mirror image of a message of a reverse printed message on a card on a light reflective surface comprising: placing a card having a reverse printed message on a holder, retaining the card on the holder with the reverse printed message exposed on top of the holder, and locating the holder and card retained on the holder adjacent the light reflective surface whereby a mirror image of the reverse printed message is reflected on the light reflective surface.

21. The method of claim 20 wherein: the reverse printed message on the card is reverse printed words or images.

22. The method of claim 20 wherein: the light reflective surface is a windshield of a motor vehicle extended upwardly from the vehicle's dashboard, said holder and card retained on the holder being located on the dashboard adjacent the windshield whereby the mirror image of the reverse printed message is reflected on the windshield.

23. The method of claim 22 wherein: the card has a dark background and a light-colored reverse printed message, slogan or image.

24. The method of claim 22 wherein: the reverse printed message on the card is reverse printed words, messages, slogans or images.
